(19) United States
(12) Patent Application Publication
(10) Pub. No.: US 2012/0268306 A1
(43) Pub. Date: Oct. 25, 2012

(54) Wireless Connectivity in a Radar Detector

(75) Inventors: Roy Coburn, Monroe, OH (US); Timothy A. Coomer, West Chester, OH (US); Jeff Stevens, Liberty Township, OH (US); John Kuhn, Sharonville, OH (US)

(73) Assignee: ESCORT INC., West Chester, OH (US)

(21) Appl. No.: 13/275,469

(22) Filed: Oct. 18, 2011

Related U.S. Application Data
(63) Continuation-in-part of application No. 12/578,377, filed on Oct. 13, 2009.
Application No. 12/578,377 is a continuation-in-part of application No. 12/389,978, filed on Feb. 20, 2009.

(51) Int. Cl. G01S 7/02

(52) U.S. Cl. 342/20

(57) ABSTRACT

A radar detector accessory permits wireless connectivity to a smartphone to enhance or improve upon the existing radar detector, by providing enhanced display of the detector status and control of the detector, including storage of false alerts and locations of interest, storage and alerting to known hazards such as speed cameras and redlight cameras. Further, using the smartphone data connection, events of interest are reported to a central server, such as radar/laser detections, police activity sightings and mobile camera sightings, and remotely reported events of these types are delivered to the smartphone for delivery as alerts to the local driver.

### CROSS-REFERENCE TO RELATED APPLICATIONS

This application is a continuation-in-part application of U.S. Ser. No. 12/578,377, which is a continuation-in-part application of U.S. Ser. No. 12/389,978 filed Feb. 20, 2009, and claims the benefit of Ser. No. 12/389,978 filed on Feb. 20, 2009. This application is also related to U.S. Ser. No. 11/620,443 filed Jan. 5, 2007, U.S. Ser. No. 10/396,881, filed Mar. 25, 2004, and U.S. Pat. No. 6,670,905, each of which claim benefit of U.S. Provisional Patent Application Ser. No. 60/139,097, filed Jun. 14, 1999, and U.S. Provisional Patent Application Ser. No. 60/145,394, filed Jul. 23, 1999. All of these applications are hereby incorporated herein in their entirety.

### FIELD OF THE INVENTION

The present invention relates to radar detectors.

### BACKGROUND OF THE INVENTION

Radar detectors warn drivers of the use of police radar, and the potential for traffic law citations if the driver exceeds the speed limit. The FCC has allocated several regions of the electromagnetic spectrum for police radar use. The bands used by police radar are generally known as the X, K and Ka bands. Each relates to a different part of the spectrum. The X and K bands are relatively narrow frequency ranges, whereas the Ka band is a relatively wide range of frequencies. By the early 1990's, police radar evolved to the point that it could operate almost anywhere in the 1600-megahertz wide Ka band. During that time radar detectors kept pace with models that included descriptive names like “Ultra Wide” and “Super Wide.” More recently, police have begun to use laser (optical) systems for detecting speed. This technology was termed LIDAR for “LIght Detection And Ranging.”

Radar detectors typically comprise a microwave receiver and detection circuitry that is typically realized with a microprocessor or digital signal processor (DSP). Microwave receivers are generally capable of detecting microwave components in the X, K, and very broad Ka band. In various solutions, either a microprocessor or DSP is used to make decisions about the signal content from the microwave receiver. Systems including a digital signal processor have been shown to provide superior performance over solutions based on conventional microprocessors due to the DSP's ability to find and distinguish signals that are buried in noise. Various methods of applying DSP's were disclosed in U.S. Pat. Nos. 4,954,828, 5,079,553, 5,049,885, and 5,134,406, each of which is hereby incorporated by reference herein.

Police use of laser has also been countered with laser detectors, such as described in U.S. Pat. Nos. 5,206,500, 5,347,120 and 5,365,055, each of which is incorporated herein by reference. Products are now available that combined laser detection into a single product with a microwave receiver, to provide comprehensive protection.

The DSP or microprocessor in a modern radar detector is programmable. Accordingly, it can be instructed to manage all of the user interface features such as input switches, lights, sounds, as well as generate control and timing signals for the microwave receiver and/or laser detector. Early in the evolution of the radar detector, consumers sought products that offered a better way to manage the audible volume and duration of warning signals. Good examples of these solutions are found in U.S. Pat. Nos. 4,631,542, 5,164,729, 5,250,951, and 5,300,932, each of which is hereby incorporated by reference, which provide methods for conditioning the response generated by the radar detector.

Methods for conditioning detector response are gaining importance, because there are an increasing number of signals present in the X, K, and Ka bands from products that are completely unrelated to police radar. These products share the same regions of the spectrum and are also licensed by the FCC. The growing number of such signals is rapidly undermining the credibility of radar detector performance. Radar detectors cannot tell the difference between emissions from many of these devices and true police radar systems. As a result, radar detectors are increasingly generating false alarms, effectively “crying wolf”, reducing the significance of warnings from radar detectors. Among the possible sources of false alarms are microwave door openers, public safety systems such as ARTEMIS, and other radar detectors. At this time, there are very few signal sources that can cause false laser detections in comparison to the substantial list of false microwave signals just described. However certain locations near airports have been demonstrated to cause such problems for various laser detector products. The issue of false signals and ways of addressing geographically fixed false sources, is addressed in the above-referenced U.S. Pat. No. 6,670,905, in which the characteristics of false sources are stored with reference to the GPS-based location of the source, so that in subsequent encounters the false source may be ignored or the response to that source conditioned.

Vehicle electronics continue to increase in sophistication; GPS receivers and satellite receivers are now commonplace. Furthermore, wireless (typically Bluetooth) connectivity to cellular telephones and cellular networks has become commonplace, permitting hands free operation and in some circumstances, Internet or text messaging (SMS) connectivity within the vehicle electronic systems. As these vehicle electronic systems continue to propagate and increase in complexity, increasingly sophisticated functionality will be available to drivers from their vehicle electronics.

For example, a common problem with navigation devices with GPS capability is that data on the device may not updated. As such, when a user inputs into his or her navigation device the location that he or she wishes to go to, the navigation device will typically calculate the route or routes to the location using the data that is not updated stored on the device. The data may have been input into the navigation device when the navigation device was first purchased, sometimes months or years beforehand, and as such, the route or routes are calculated with data that is not updated. But to improve the calculation of routes, some navigation devices may request that a server calculate the route or routes. For instance, the server may include traffic data and therefore the route(s) the server calculates may take into account the traffic data. The server then may transmit back to the navigation device a route that does not appear to have any traffic jams. Thus, some navigation devices with GPS capability have modems built into the devices to receive the route or routes from the server.

Furthermore, some navigation devices download traffic data from servers. The device typically needs to initiate the contact with the server by requesting the traffic data, otherwise, the server does not communicate with the device. Thus, some navigation devices with GPS capability have modems built into the devices to receive updated traffic data.

Data may also be transmitted, typically one way, from a sub-carrier or stations to a navigation device to display the name of the song and artist for a song playing in the vehicle. This data may be transmitted by FM broadcast and/or received by a modem of the navigation device.

Moreover, an application from Trapster is available for iPhone devices, BlackBerry devices, some Android devices, some Nokia devices, and other devices, which follows a driver's location as a dot on a map via GPS capability, and when the driver passes a police officer lurking by the side of the road with a radar gun, the driver may tap on his or her iPhone, for example, to mark the location as a speed trap point. That data point may then be sent to a server so that other drivers using Trapster can then be alerted of that speed trap when they approach that point on the map. The driver may report the location of live police traps (e.g. police with radar or laser guns set up), red light cameras, speed cameras, or usual police hiding spots, using the shortcut keys or menu items on the mobile phone. Thus, via the application, the iPhone may transmit to and receive data from Trapster's server.

In particular, the driver may view on his or her iPhone screen a list of the traps near the driver and the distance to each one, with the data received from the server. The application gives the driver data about when the trap was reported, the confidence level, and who reported it, and allows the driver to rate traps that were reported by other users based on whether the driver agrees or disagrees with a trap. Colors are used to indicate the “confidence” of the trap, and the confidence is incremented when different users report the same trap at the same location from their mobile device or when users rate traps via the Trapster website. Further, if a driver reports a trap, and others corroborate that report, then that driver's Karma score goes up as well.

Besides viewing the traps, the driver may be alerted (e.g., audio alerts) when he or she approaches previously reported traps, and may also get alerts for new live police reports in his or her area via text message. Indeed, some versions support viewing traps on a map, while in others, the alerts are shown as a textual description in the main application window.

Recently, Cobra has released a radar detector product known as iRadar, which connects to an iPhone application via a Bluetooth connection so that the iPhone application serves as a display console for the radar detector. Through the iPhone application the driver may obtain details on radar detections, as well as warnings of known speed camera and redlight camera locations. The database of cameras and speed traps is updated using the data connection of the iPhone. Furthermore, the user may mark areas where the user believes caution is advised.

Although the enhancements described have aided drivers, nonetheless, further enhancements may be made to reduce inaccuracies and improve a driver's experience.

### SUMMARY OF THE INVENTION

In one aspect, the invention features a radar detector accessory comprising a housing that incorporates a cigarette lighter plug for obtaining 12 volt power from a cigarette lighter connector, a connector for providing power to a radar detector and exchanging control signals with the radar detector, and a personal area network interface for connection to the smartphone device to permit data exchange with the smartphone device.

In the disclosed specific embodiment, the accessory further comprises a power output connector usable to supply power to a smartphone device. Further, the smartphone device incorporates a global positioning system which is used in conjunction with the radar detector accessory to associate radar detections with a geographic location. The wireless device interface comprises a radio compliant with one or more of: Bluetooth, Zigbee, or 802.11 personal area network communication protocols. The smartphone is programmed to interact wirelessly via the wireless device interface to obtain or store data related to positions and data relative to possible police activity at those positions. Further, the smartphone is programmed to forward data on possible police activity detected by the radar detector to a remote server via a smartphone data connection.

In the specific disclosed embodiment, the smartphone may also receive data on possible police activity detected by the radar detector from a remote server via a smartphone data connection, and display a warning of the same on a display of the smartphone.

In the specific embodiment, the radar detector accessory controls a display on the radar detector in response to control signals from the radar detector accessory.

The above and other objects and advantages of the present invention shall be made apparent from the accompanying drawings and the description thereof.

### BRIEF DESCRIPTION OF THE DRAWING

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is an schematic diagram of a communications network linking smartphone users who are customers of the system described herein, including users having radar detectors and users without radar detectors.

FIG. 2 is an isometric diagram of a radar detector accessory in accordance with principles of the present invention, which provides connects to a 12 volt outlet in a vehicle and provides connectivity between a radar detector and smartphone device.

FIG. 3 is a disassembled perspective view of the radar detector accessory of FIG. 2 showing the internal structure thereof including the circuit board.

FIGS. 4A and 4B are cross sectional views of the radar detector accessory of FIG. 2 showing the layout of the circuit board on its two sides.

FIGS. 5A, 5B, 5C, 5D, 5E, 5F, 5G, 5H, 5I and 5J are screen displays generated by a smartphone operating in conjunction with a radar detector in a configuration such as is shown in FIG. 1A.

### DETAILED DESCRIPTION OF SPECIFIC EMBODIMENTS

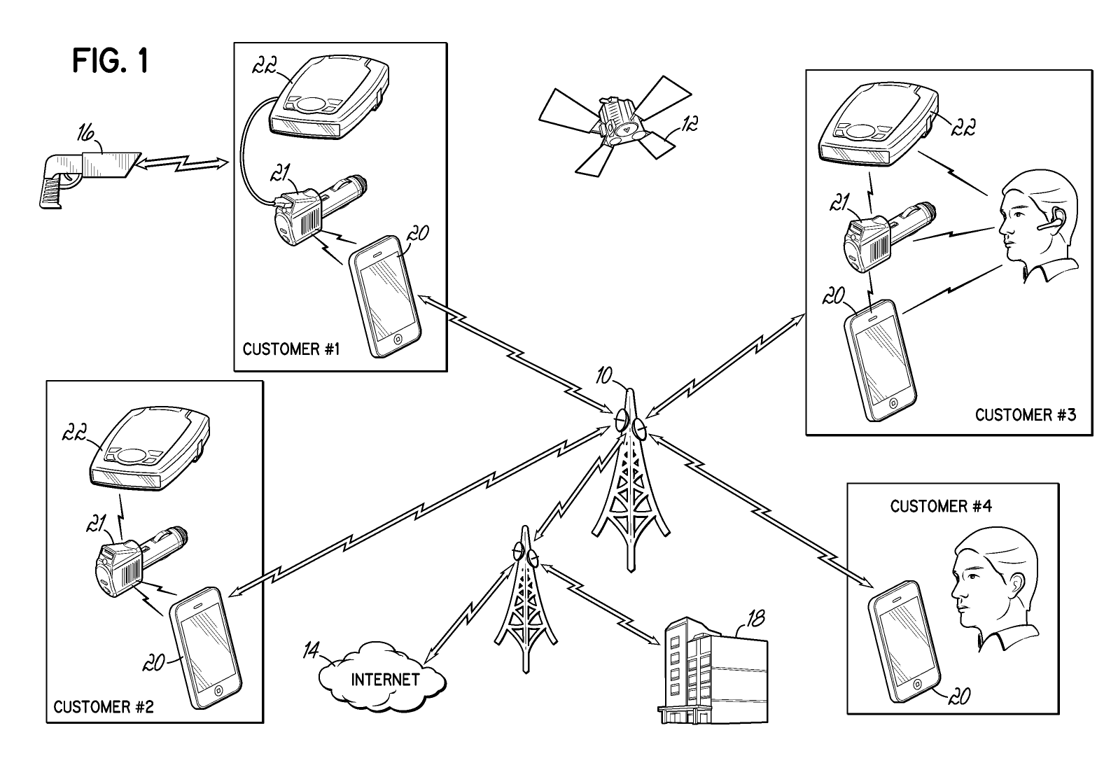

Referring now to FIG. 1, a radar signal detection and warning network uses wireless communication via cellular towers 10, each coupled to a customer (e.g., customer 1, customer 2, customer 3, customer 4) to enable communication between the customers of information relevant to each of them relating to police activity. Each customer uses a smartphone device 20, able to communicate data wirelessly and provide a display for presentation and collection of data. Suitable smartphones are so-called smart phones such as the various generation iPhone devices sold by Apple, devices running the Android operating system, and smart phones of other software platforms such as Blackberry, Windows mobile, and the like.

Preferably, the smartphone devices are able to capture location information for the device using radio signals received from GPS satellites 12. Based on this information, the wireless devices are able to obtain relevant information to their current location, and provide information alerts regarding a current location.

As illustrated in FIG. 1, the devices collectively communicate via a centralized server, typically at a home office 18 of the proprietor of the communication network. Internet communication, wired or wireless communication, via the Internet 14 or proprietary networks, may connect the home office to the smartphone device of each customer.

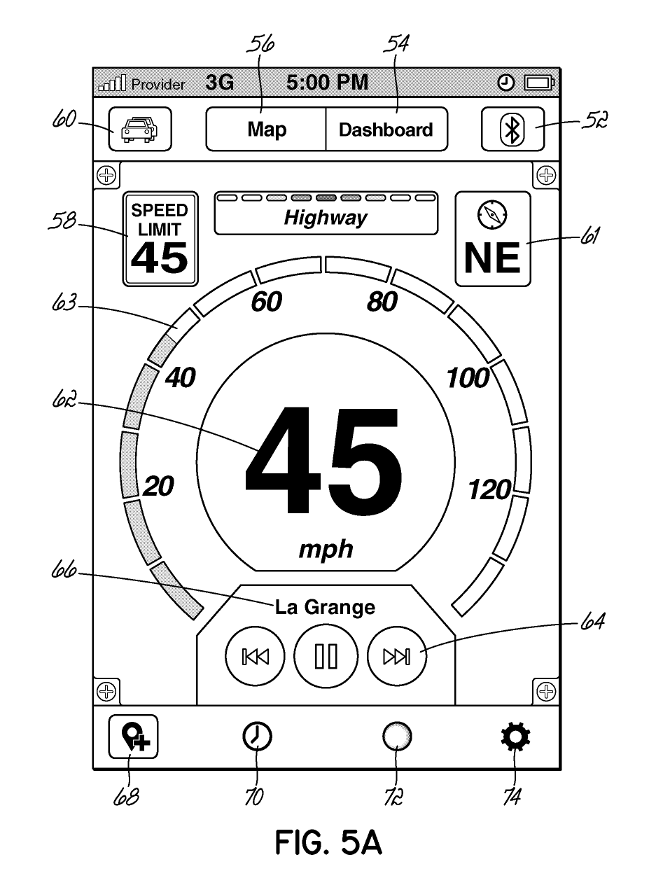

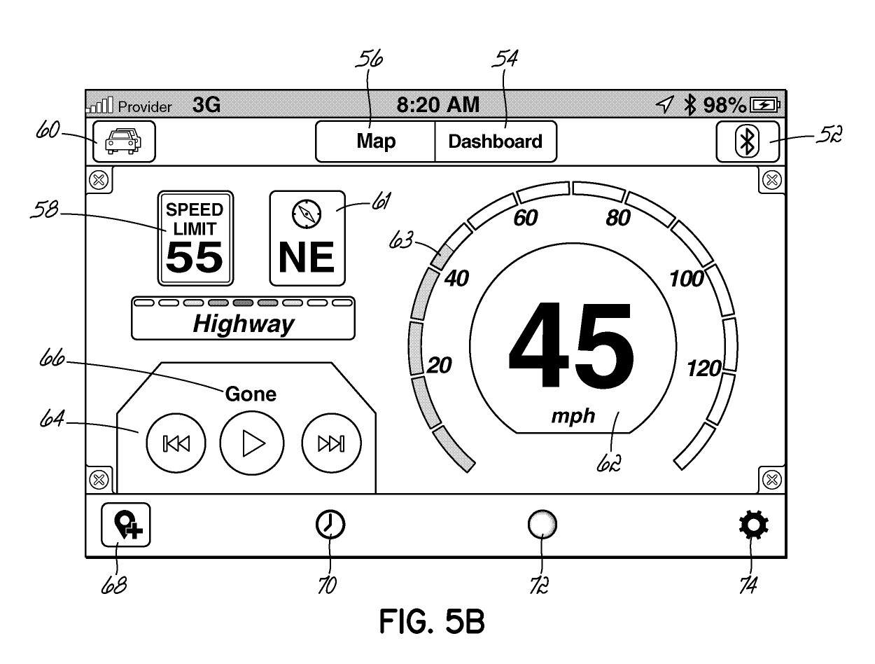

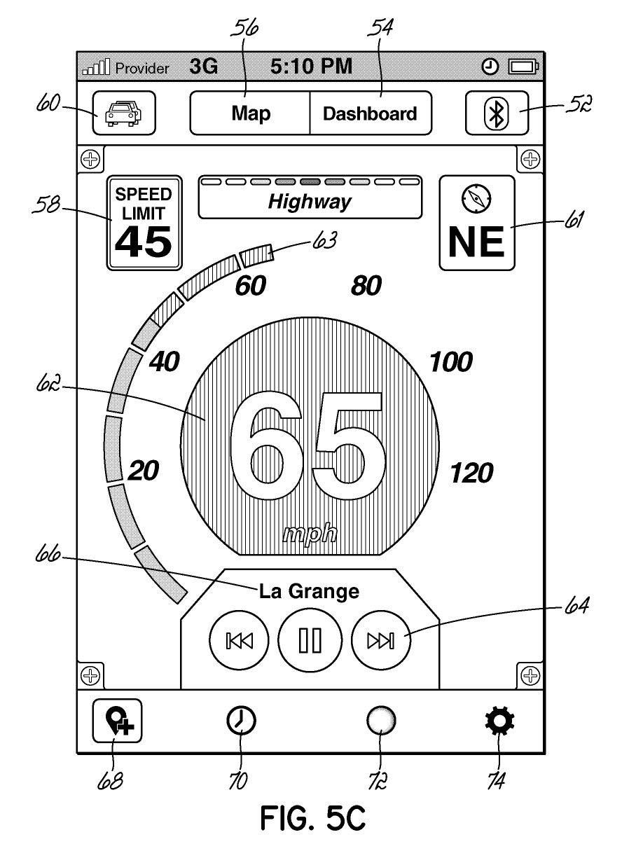

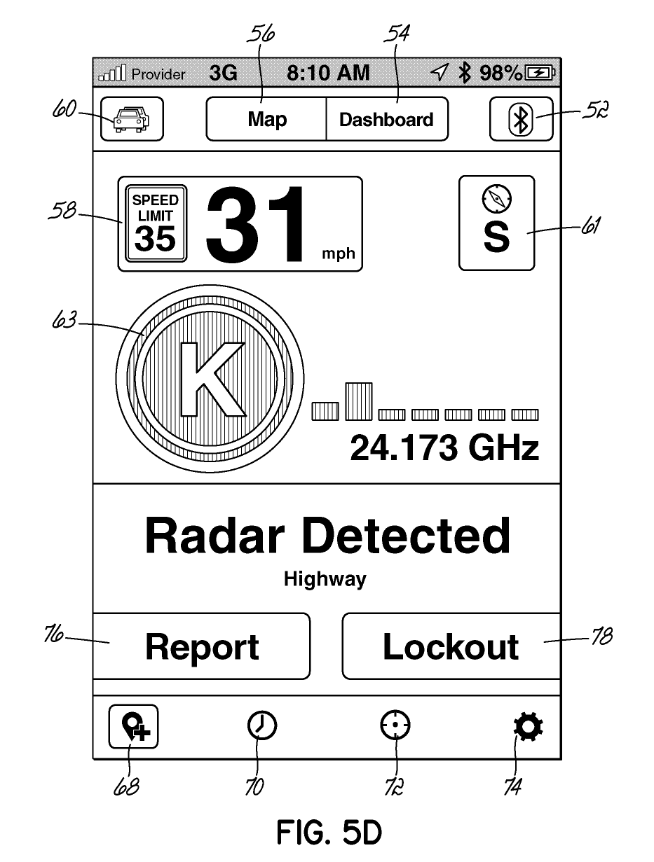

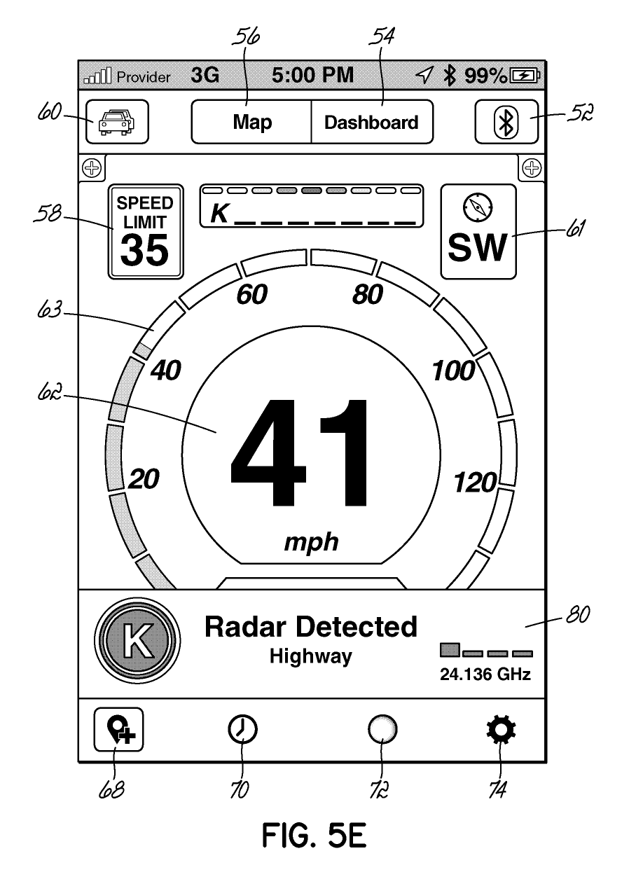

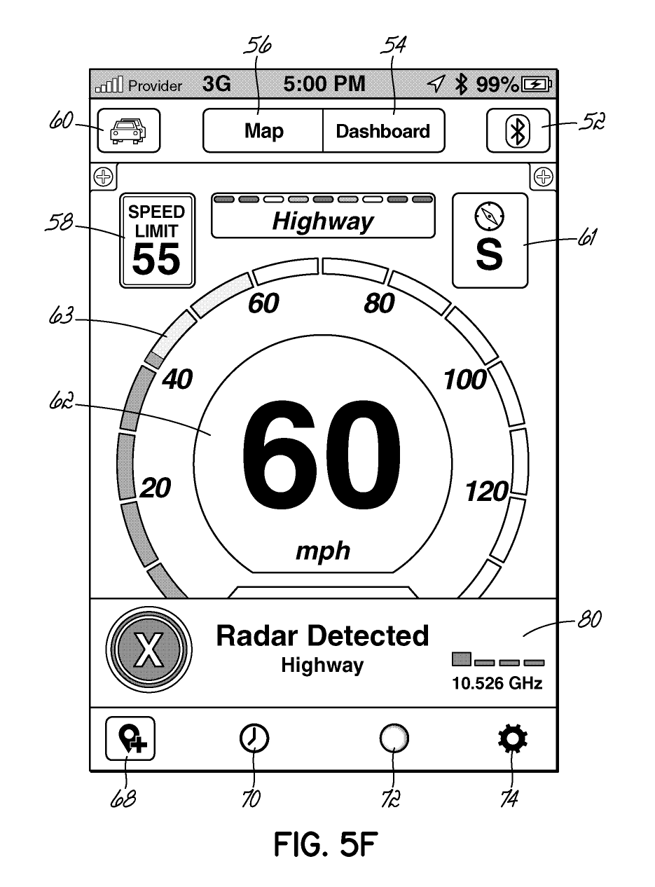

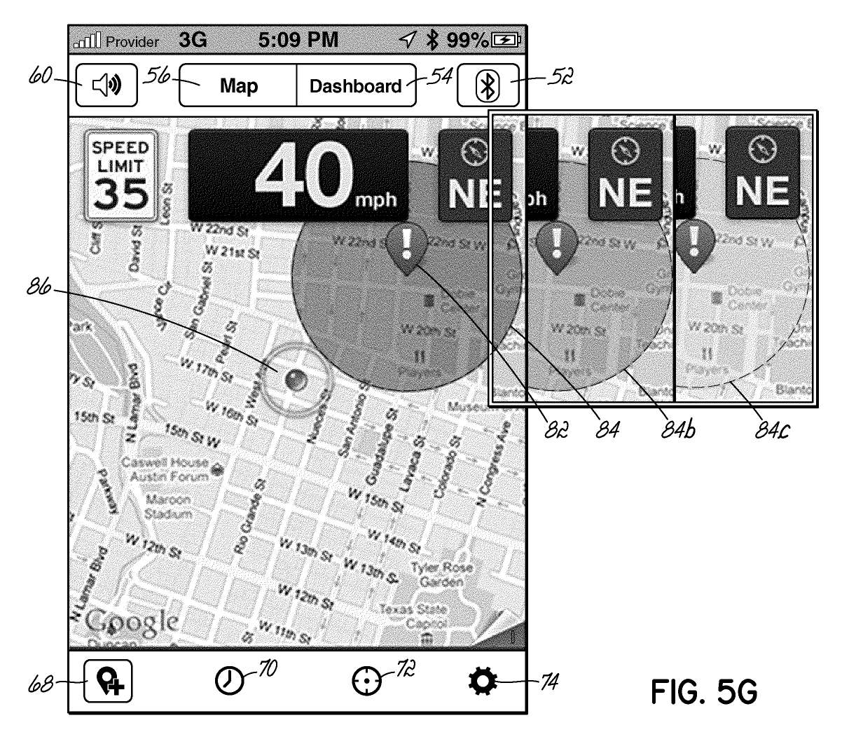

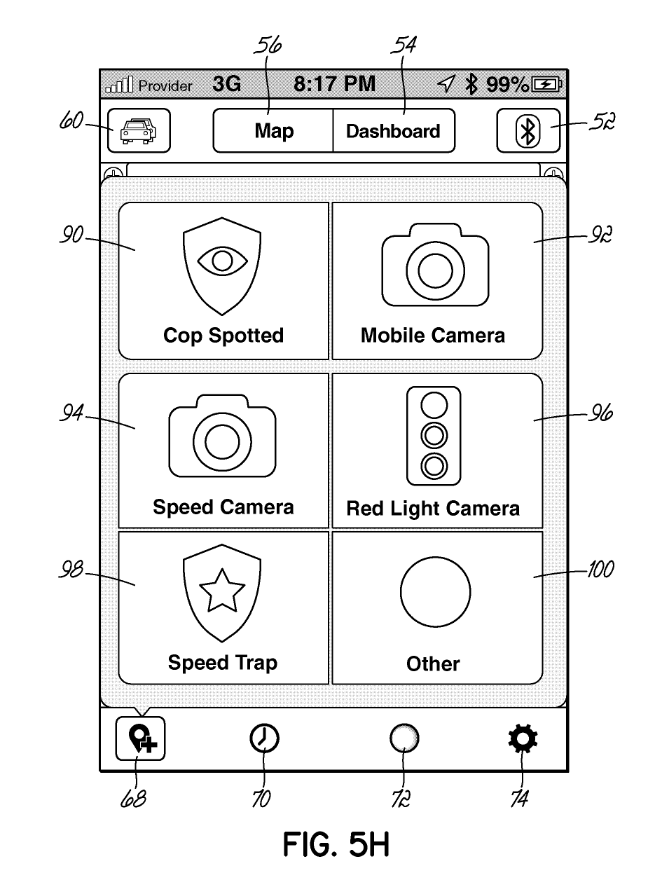

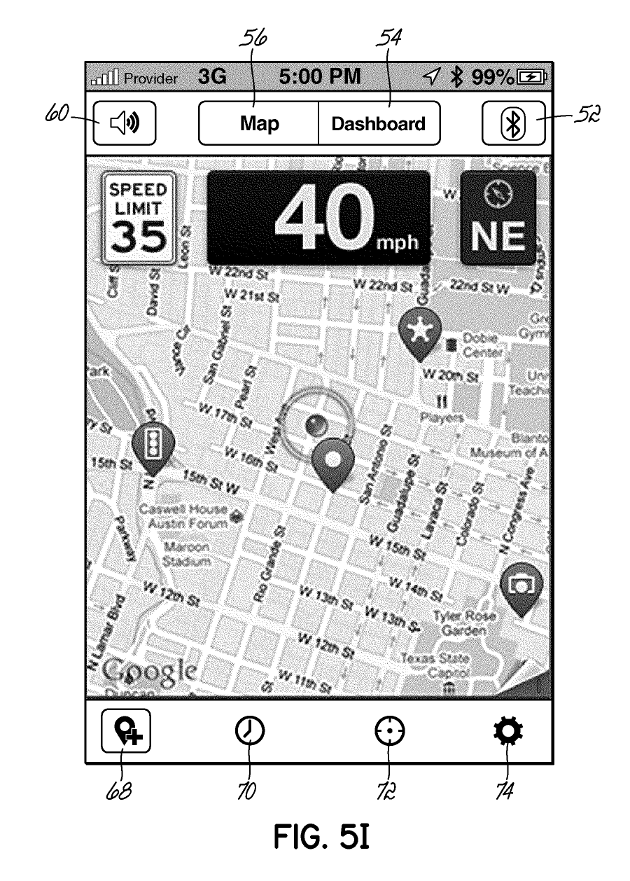

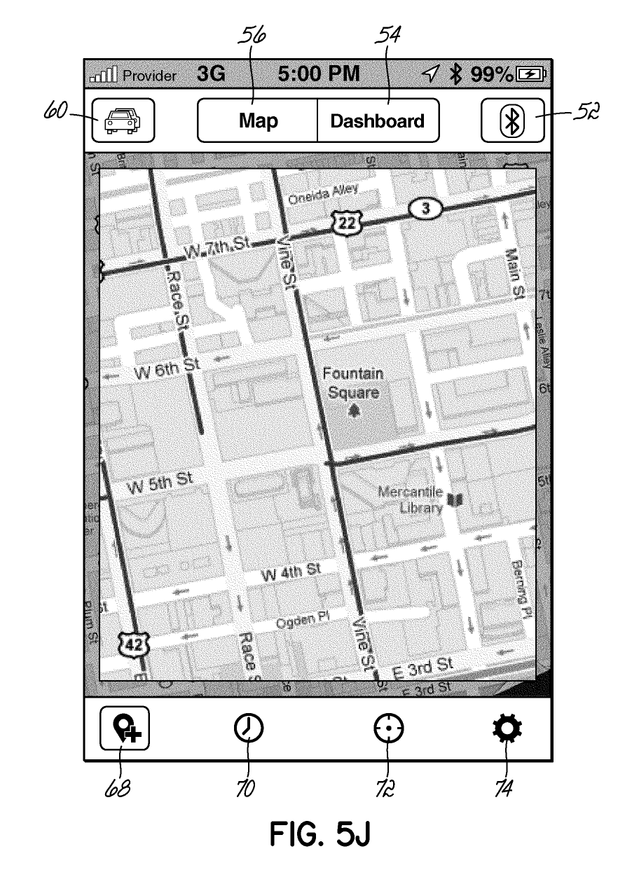

Two types of customers are contemplated according to principles of the present invention. A first type of customer, illustrated by Customer 1, Customer 2 and Customer 3, uses a smartphone device 20 coupled (via a wired connection or, in the present embodiment, via Bluetooth connectivity) to a radar detector accessory 21, which is connected to a radar detector 22. Using these connections, radar alerts identified by the radar detector 22 (e.g., from radar gun 16 which is irradiating customer 1) may be reported via the accessory 21 to the smartphone device 20 which may perform various functions under control of software, which will be elaborated below with reference to FIG. 5A et seq. Specifically, the alert type and details from radar detector 20 may be reported on the display screen of the smartphone device 20. In addition, the smartphone device 20 may be caused to report the radar detector alert to a server at the home office 18, and this server may then report the radar detector alert to other customers via their smartphone devices, so that an alert may be reported to other customers in the vicinity of customer 1. Furthermore, principles of the present invention contemplate a second type of customer, that does not have a radar detector and is only connecting to the network via a smartphone device, such as customer 4 shown in FIG. 1. In accordance with principles of the present invention alerts from a radar detection at one customer may be provided to customers that do not have a radar detector such as customer 4, thus providing an enticement to participate in the network.

Principles of the present invention also contemplate the manual delivery of warnings from customers to other customers. For example, a police vehicle on station at a speed trap may be seen by customer 4 and manually noted in the smartphone 20 of customer 4. This manual notification may then be delivered to a server in home office 18, which then propogates the notification (potentially after confirmation from other customers), to those customers near to the location of the identified police activity. In this manner, both actual radar events and manual indications of police activity may propogate through the network between customers.

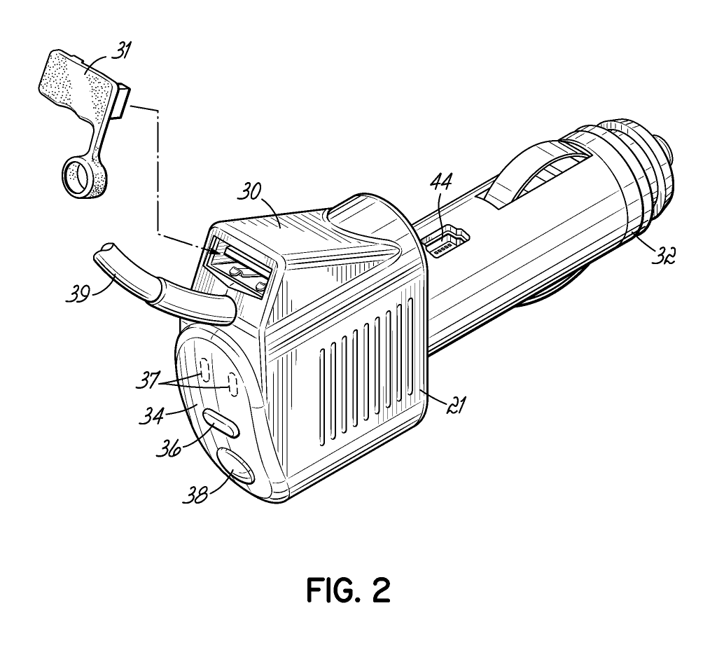

Referring now to FIG. 2, details of the radar detector accessory 21 can be discussed. The accessory housing takes the form of a plug for a 12 volt outlet, having a first end 32 sized for insertion in a standard 12 volt outlet and a second end 34 with a display and control panel. Between these ends, the housing includes openings for various connections, including an an opening 30 including a USB power plug (covered when not in use by rubber cover 31), which may be used to provide USB power to a smartphone or other device within a vehicle. Also included is a mini-B USB connector 44 for connection of the internal circuits of accessory 44 to a host computer for updating of software in the accessory 21. The display and control panel at end 34 includes a muting button 38 and report button 36, which are used as detailed below to control a smartphone that is connected to the accessory 21. The panel at end 34 further includes status lights, usable to indicate the power status of accessory 21 and to indicate when a warning condition has occurred.

Accessory 21 also includes a connection cord 39 for connection to a radar detector, to provide power to the radar detector and to communicate control data to and from the radar detector, including the nature of any alert being generated by the radar detector, and control signals to mute or generate a display on the panel of the radar detector.

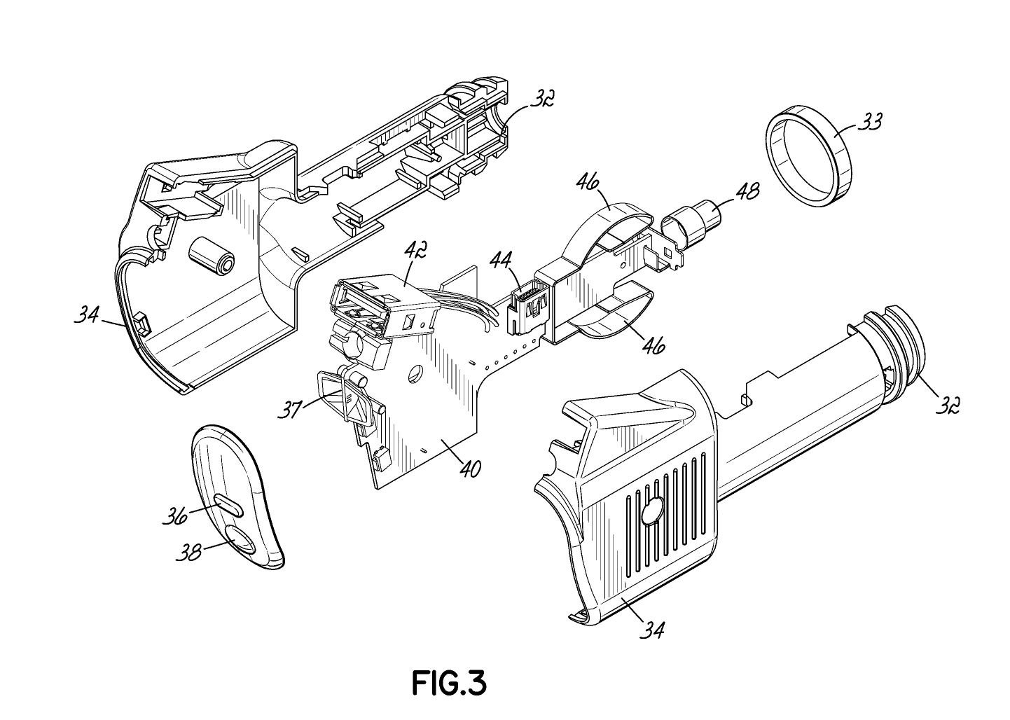

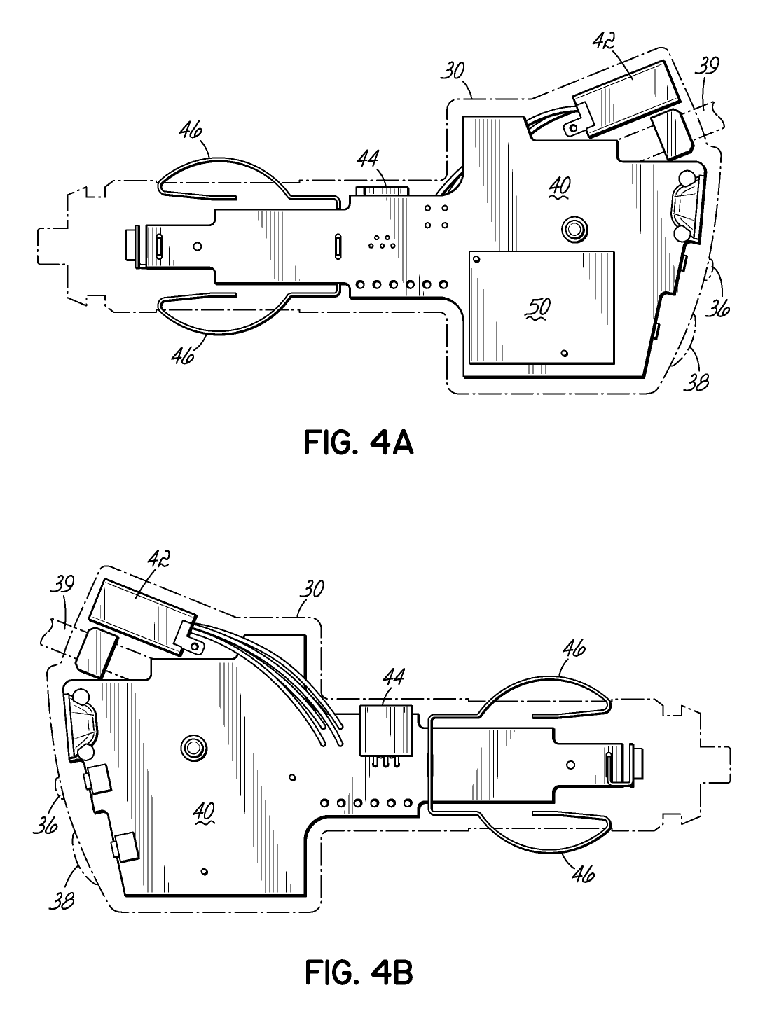

FIGS. 3, 4A and 4B illustrate the internal structure of the device accessory 21. The device includes an internal circuit board 40 which includes a programmable microcontroller, Bluetooth radio, and power supply circuit. The programmable microcontroller communicates via cord 39 (FIG. 2) with the radar detector to identify the form of radar detection being generated, control the radar detector to produce or mute an alert signal, and to present information on the text display on the radar detector. Furthermore, the microcontroller stores software upgrades to be uploaded to the radar detector through the cord 39 as necessary to enable functions of the radar detector usable by the accessory 21. The microcontroller further communicates via USB interface 44 to obtain software updates from a host PC, useable either by the microcontroller itself or by a radar detector after upload through cord 39. Finally, the microcontroller detects keypresses upon the mute button 38 and report button 36 and generates control signals for lights 37.

Circuit board 40 also includes a personal area network radio 50, such as a radio compliant with the Bluetooth standard. The microprocessor on circuit board 40 controls the radio 50 to pair with a smartphone using a standard pairing procedure, and thereafter communicate with the smartphone to deliver radar detection information to the smartphone and receive control signals which mute the radar detector, generate alerts from the radar detector and/or cause the radar detector display to present information generated by the connected smartphone.

Circuit board 40 further includes power supply circuits for converting 12 volt power to a suitable 5 volt output on USB power plug 42, so that the conditioned power thereby produced may power the operation of a smartphone or other device that is chargeable via a USB plug. The power supply also provides power to operate the microprocessor and radar detector (via cord 39), and the radio 50.

Referring now to FIG. 5A et seq., screen displays will be used to explain details of the operation of the network of FIG. 1 and in particular the interaction of smartphone 20, accessory 21, and radar detector 22. FIG. 5A illustrates a “dashboard” view of an application which runs on the smartphones 20 shown in FIG. 1. This dashboard view includes various touch screen controls. In the top row, the application includes an icon 52 indicating whether a Bluetooth connection has been established with a paired accessory 21. Pairing with an accessory is required for several functions of the application. In an adjacent location in the top row, are buttons 54 and 56 which are used to select between the dashboard view shown in FIG. 5A and a map view which is discussed in greater detail below with reference to FIGS. 5G and 5I. Also included in the top row is a button useable to generate a traffic view as shown and discussed below with reference to FIG. 5J.

The central display panel of the “dashboard” view provides a number of vehicle operation basic facts, including a compass display 61, local speed limit display 58 and vehicle speedometer 62/63. The vehicle speed and compass heading is derived from the GPS circuitry in the smartphone which must be enabled for these operations. The speed limit information is obtained from the server at the home office 18, which stores a speed limit database; the current location of the smartphone as reported by the GPS circuitry is delivered to the home office 18 and the speed limits of nearby roads are returned for use in generating this display. The vehicle speed is displayed in the form of a speedometer including a central digital display 62 of the current vehicle speed, and a dial display 63.

A lower portion of the main display includes controls for the smartphone music player, including track information in a display area 66 and pause, next track and previous track controls in an area 64, so that the driver may readily use the smartphone as a music player while remaining in the “dashboard” view.

A bottom area of the “dashboard” display includes additional controls. A “report” button 68 is used to report locations of interest. This touch screen button has the same function as the report button 38 on the accessory 21, and permits reporting of location as elaborated below in connection with FIG. 5H. Also included in the bottom row is a history button 70 which may be used to retrieve a history of recent radar alerts, location reports, and other activity of the application. A color button 72 may be used to change the display colors of the application. Finally, a settings button 74 may be used to establish settings of the application, such as Bluetooth pairing, the nature of over-speed alerts, and the like.

FIG. 5B illustrates a landscape version of the dashboard view, in which like controls are identified with the same reference numerals identified in the above discussion.

FIG. 5C illustrates the feedback provided by the application in the event that the vehicle speed exceeds the speed limit for the current location. In the illustrated example, the overspeed condition is indicated in to ways: first, speedometer dial 62 changes colors, and second, the dial display 63 changes colors indicating the amount of overspeed. The application may also cause verbal warnings of overspeed to be given to the driver, if desired. The settings for the application can be used to define whether overspeed warnings are provided, and if so, the amount of excess speed above the limit that triggers the warning.

FIG. 5D illustrates the display generated when a radar alert is generated by the attached radar detector 22 which has not been locked out. In this circumstance visual and audible feedback will be provided to the user from the detector and from the smartphone 20. On the smartphone screen, as seen in FIG. 5D, the speed limit display 58 is expanded to identify the vehicle's current speed, and radar alert information is presented in the central display area which normally includes the vehicle speedometer. As can be seen, the central display area indicates the type of radar (which is K band at 24.173 GHz in the illustrated example) and presents a Report button 76 and Lockout button 78 to the user.

If the user responds to the radar alert by pressing the report button 78 on the screen shown in FIG. 5D, or the report button 36 on the accessory 21, then the application will report the received alert and the location of the smartphone 20 to the central server at the home office 18, so that this information may be evaluated and reported to other members of the network illustrated in FIG. 1, as discussed in further detail below. After reporting, the central area of the display of the smartphone 20 will change to the display shown in FIG. 5E, in which the speedometer display 62 and 63 is presented in the same fashion as seen in FIG. 5A, and an overlay panel 80 is also displayed showing the band and frequency of radar that is being detected. Overlay panel 80 includes bright red colors to increase awareness of the alert. Overlay panel 80 will be displayed as long as the radar alert persists, and will be removed when the radar alert ends. Audible and visual feedback from the detector may also be reduced after the alert has been acknowledged and reported.

If the user responds to the radar alert in FIG. 5D by pressing the lockout button 78, then the smartphone 20 will generate a confirmation screen to confirm the user's request to lock out the reported signal, and in response to confirmation, smartphone 20 will store the location and frequency of the reported signal in a database in the application in order to prevent future alerts relating to the signal. When the radar alert has been locked out, the central area of the display of the smartphone 20 changes to the display shown in FIG. 5F, in which the speedometer display 62 and 63 is presented in the same fashion as seen in FIG. 5A, and an overlay panel 80 is also displayed showing the band and frequency of the locked out radar alert that is being detected. In this case, the data in overlay panel 80 is shown in a grey color, indicating that the radar alert has been locked out. It will be appreciated that, once an alert has been locked out by the process described above, future radar alerts of similar band and frequency received in the same area, will not cause display of the alert screen of FIG. 5D, but instead will only cause an overlay panel 80 to appear as shown in FIG. 5F, thus minimizing the response of the smartphone to the radar signal. Furthermore, audible response to the alert by the detector is typically eliminated when a locked out alert is generated by the detector, and visual feedback of the alert on the display of the detector is either eliminated or reduced to a minimum.

The driver can also respond to an alert using the buttons on the accessory 21. In response to an alert display as seen in FIG. 5D, the driver may depress the mute button 38 on the accessory 21; in the event of such a response, the smartphone 20 reduces the visual and audible feedback for the alert on the detector display, and cause the smartphone display to transition to the display shown in FIG. 5E. This reduces feedback on the alert while maintaining active notice of the alert. In the event the driver presses the mute button 38 a second time, this is taken as an indication that the driver wishes to lockout reporting of the alert, and in response the smartphone 20 will generate a confirmation display. If the driver presses the mute button 38 again in response to the confirmation display, then the alert type and frequency will be stored in the database on the smartphone 20 and the display will transition to the display shown in FIG. 5F.

When a locked out alert is being indicated using the screen of FIG. 5F, the driver may unlock the alert by depressing the mute button 38. In the event of such a response, the smartphone 20 will request confirmation to unlock the alert, and the driver may then confirm this by depressing the mute button 38 a second time, or by responding on the touch screen of the smartphone 20.

As an alternative to the methods described above, the user may respond to alert displays with gestures on the touch screen of the smartphone 20—for example, when the display of FIG. 5D is active, indicating a current alert, the driver may finger swipe to the left on the touch screen instead of pressing Report button 76, to indicate the alert should be reported, with the same results as pressing the Report button 76 discussed above. Similarly, the driver may finger swipe to the right on the touch screen instead of pressing the Lockout button 78, to indicate an alert should be locked out, with the same results as pressing the Lockout button 78 as discussed above. Also, a finger swipe to the right on the display of FIG. 5F can be used to indicate that a locked out alert should be unlocked, with the same effect as pressing the Mute button 38 on the accessory 21.

As noted above, driver confirmation of a radar alert is sought before the alert is reported to the central server at the home office 18. Driver confirmation of an alert is useful when the frequency band of the alert is often used by non-police sources of radar, such as door openers, traffic sensors, and the like. However, not all radar bands or frequencies are commonly used by non-police sources. In particular, the Ka radar band is not typically used by non-police radar sources, and similarly, laser bands are not typically used by non-police radar sources. Accordingly, in one embodiment of the present invention, Ka band and laser alerts are reported to the central server at the home office 18 automatically, and the driver is not required to press a report button or finger swipe the screen of the smartphone 20 to report these alerts. This approach ensures that likely police activity is reported consistently by all customers in the network of FIG. 1.

As noted above, when alerts are reported to the central server at the home office 18, these alerts may then be reported to other customer smartphones 20 in the network of FIG. 1. The central server may require confirmation of the alert, e.g., the alert may be required to be twice reported by different customers before it is considered confirmed. However, when an alert has been confirmed, the location and type of the alert is then delivered to other smartphones 20 that are reported to be at geographic locations near to the alert. Each smartphone 20 may then compare the location of the alert to a current location, and if the alert is sufficiently close, generate a warning to the driver of the network reported radar alert. This function may permit the smartphone 20 to warn of police activity further in advance than is possible with radar detection alone. Furthermore, customers such as customer 4 in FIG. 1 who do not have a radar detector may benefit from police activity warnings of the kind previously available only with the use of a radar detector.

FIG. 5G illustrates the map display screen of the smartphone application, and the graphical data presented in response to a network-reported radar alert. The location of the network-reported alert appears as an icon 82, and a radius surrounding the alert is shaded on the map in red to indicate the area in which the alert will be considered relevant to the driver. If the smartphone 20 (whose location is indicated by dot 86) enters the area indicated by shaded display 84, the smartphone 20 will alert the driver of the network-reported alert.

Entry of the smartphone 20 into the vicinity of an alert will be reported in a similar fashion as a radar alert as discussed above with reference to FIGS. 5D through 5F. The driver may mute the alert, or confirm the alert. The driver's confirmation of the alert, or failure to do so, may be reported to the central server at the home office 18 to aid in identifying those alerts that are relevant at a particular time.

It will be appreciated that network-reported alerts are time-sensitive; some time after the reporting of a network alert, if the alert has not been re-confirmed, the validity of the alert is questionable as the police activity at the noted location may have ended. To reflect this, network alerts are time stamped when received by the central server at home office 18, and are reported along with the time stamp. A given time period after the time stamp, such as 30 minutes, the alert is removed from the database at the central server and from the smartphone 20.

The age of an alert is also visually indicated to the driver by the color of the shaded area 84; older network-reported alerts are indicated by an orange shaded area as seen at 84b, and nearly expired network-reported alerts are indicated by a yellow shaded area as seen at 84c.

Embodiments of the present invention permit the driver to report locations and events in the absence of a radar alert. This may be done by depressing the Report button 36 on accessory 21 when no alert is active, or by depressing the report button 68 on the smartphone 20 screen. When the user requests to report a location in either manner, the smartphone display 20 presents the menu shown in FIG. 5H, through which the driver may indicate the type of location or event that the driver wishes to report.

Two types of locations may be reported to the central server for presentation to other customers in the network of FIG. 1: (1) a “Cop Spotted” location, indicated by button 90, where the driver has seen police activity indicative of speed monitoring; and (2) a “Mobile Camera” location, indicated by button 92, where the driver has seen a temporary installation of a mobile speed camera. These locations will be reported to the central server, and potentially pending confirmation, re-reported to other customers near to the reported locations.

The driver may also store locations for personal reference, without network reporting. Four types of locations may be stored for personal reference: (1) a “Speed Camera” location, at which the driver has seen a fixed speed camera not otherwise known to the application; (2) a “Red Light Camera” location, at which the driver has seen a red light camera not otherwise known to the application; (3) a “Speed Trap” location, at which the driver has seen regular police activity in conjunction with speed limits that the driver considers a speed trap; and (4) an “Other” location, which may be any point of interest to the driver such as a favorite restaurant, friend's home, etc.

Referring to FIG. 5I, the map display includes icons for reported locations including personal locations generated by a driver, and network locations generated by the driver or other drivers in the network of FIG. 1. In addition, the smartphone 20 may obtain information on the known location of redlight cameras and speed cameras from a database in the central server, and present these on the map display as well. FIG. 5I illustrates an icon for a redlight camera and speed camera as reported from the central server database, an icon for a “cop spotted” reported by any one of the network customers shown in FIG. 1 and delivered to the smartphone 20, and a personal “other” location reported by the user of the particular smartphone 20 generating the display of FIG. 5I. As these locations are approached by the smartphone 20, an alert of the upcoming location will be generated to the driver in the manner described above with reference to FIGS. 5D through 5F. When alerted, the driver may mute the alert, or confirm the alert. In the case of a network-originated alert to a “cop spotted” or “mobile camera”, the driver's confirmation of the alert, or failure to do so, may be reported to the central server at the home office 18 to aid in identifying those alerts that are inaccurate or no longer relevant at a particular time.

FIG. 5J illustrates a live traffic display, which may be enabled by the use of the traffic button 60 in the upper area of the smartphone 20 display. The traffic map is generated from traffic data sources available to the smartphone 20 such as the google maps application. Traffic data may be incorporated into the map display shown in FIGS. 5G and 5I, or may be presented on a separate overlay as seen in FIG. 5J.

As noted above, the display on the detector 22 may be controlled by the application in the smartphone 20 via wireless communication to the accessory 21 and wired communication to the detector 22 via cable 39. This capability permits useful feedback to be delivered from two different sources which are visible in different locations in the driver's vision. In particular, the display on the radar detector is typically a text/numeric display which can provide rapid visual feedback without directing attention away from the road.

In one example, the radar detector display is controlled by the smartphone 20 application to produce the following displays:

No detection: “Highway”, “City” or “Auto”—reflecting the sensitivity mode of the detector—which is also reflected on the smartphone application display as seen in FIG. 5A.

Alert: Alert frequency or bar graph, or vehicle speed, as in normal operation for the detector. Approaching area of network-reported alert: Visual indication of alert such as “Cop Reported” or “Mobile Camera”, and audible chirp or voice. Approaching stored speed camera (from central server database or personal stored locations): Visual indication of alert such as “Speed camera” and audible chirp or voice.

It will be appreciated that the embodiments illustrated above are exemplary and not limiting, and that other embodiments of the present invention fall within the scope of the appended claims. For example, the features shown in the accessory 21 may be integrated into an under-dash unit rather than a housing coupled to the power plug. The vehicle's built-in electronics may also incorporate any or all of the functions described. In some embodiments, for example, the detector 20 include a Bluetooth or other personal area network to enable connection with a smartphone 20, without requiring an accessory 21, or the detector may include an embedded cellular data modem and/or GPS receiver in which case the data communications and location identification described herein may be performed by the radar detector instead of a connected smartphone 20, in which case the connected smartphone 20 may be replaced with a table or palmtop device such as an iPod touch, iPad, Galaxy tablet, or a smartphone 20 that does not have or that the driver prefers not use cellular data service.

The invention is thus not limited to the embodiments disclosed but is defined by the following claims.

1. A police activity warning system, comprising:
a global positioning receiver providing a location;
a detector of electromagnetic signals indicative of police activity;
a modem coupled operable to wirelessly communicate information regarding potential police activity with a server external to the system;
a display for presenting a map of locations; and
at least one hardware based processor coupled to the global positioning receiver, detector, display and modem, the processor operable to obtain a location from the global positioning receiver and control the display to present a map of locations adjacent to the location, and operable to obtain an alert of electromagnetic signals from the detector, and control the display to present data regarding the status of the detector, the processor further operable to control the modem to wirelessly receive information on potential police activity from a source external to the system, and control the display to present the received information on potential policy activity on the map.

2. The system of claim 1 wherein the potential police activity is displayed as a shaded area on the map.

3. The system of claim 2 wherein the color of the shaded area is indicative of the currency of the reported potential police activity.

4. The system of claim 1 further comprising a detector of electromagnetic information indicative of potential police activity, wherein the processor is further operable to receive an alert from the detector and control the modem to transmit a location and information on the alert to a central server.

5. The system of claim 4 wherein the processor is further operable to determine whether a warning should be issued to a driver in response to a received alert based upon stored information regarding false alerts and the locations thereof.

6. The system of claim 4 wherein the processor is further operable to determine whether to transmit a location and information on the alert to the central server.

7. The system of claim 6 wherein the processor transmits a location and information on an alert to the central server when the alert indicates electromagnetic signals in a particular frequency band.

8. The system of claim 6 wherein the processor requests a user's confirmation of whether a location and information on an alert ought to be transmitted to a central server prior to transmission thereof.

9. The system of claim 8 wherein user confirmation is obtained by gestures made by the user and detected by the processor.

10. The system of claim 9 wherein the display is a touch screen and said gestures are swipes by the user on the touch screen.

11. The system of claim 4 wherein the processor is further operable to determine whether to store a location and information on the radar alert in a false alarm database.

12. The system of claim 11 wherein the processor requests a user's confirmation of whether a location and information on an alert are a false alert.

13. The system of claim 12 wherein user confirmation is obtained by gestures made by the user and detected by the processor.

14. The system of claim 13 wherein the display is a touch screen and said gestures are swipes by the user on the touch screen.

15. A police activity warning system, comprising:
a detector of electromagnetic signals indicative of police activity and a first display, the detector and first display being incorporated within a first housing;
a second display and a hardware based processor, the second display and processor being incorporated within a second housing;
the processor in wireless communication with the detector and first display;
the processor in wireless communication with the detector to obtain an alert of electromagnetic signals from the detector and in communication with the second display to present data regarding the status of the detector;
the processor further in wireless communication with the first display to present data regarding the status of the processor or detector on the first display

16. The system of claim 15 wherein the processor and second display are incorporated within a smartphone.

17. The system of claim 15 wherein the first display is a text display and the second display is a graphical display.

18. The system of claim 15 further comprising a modem in wireless communication with a remote server, wherein the processor is further operable to receive an alert from a remote server and control the first and second displays to present information regarding the alert from the remote server.

19. A police activity warning system, comprising:
a detector of electromagnetic signals indicative of police activity;
a display for presenting data generated by the detector; and
at least one hardware based processor coupled to the detector and display, the processor operable to obtain an alert of electromagnetic signals from the detector and control the display to present data regarding the status of the detector; the processor further operable to provide playback of audio files and display controls for playback of audio files on the same display as data regarding the status of the detector.

20. A police activity warning system, comprising:
a global positioning receiver providing a location;
a modem coupled operable to wirelessly communicate information regarding potential police activity with a server external to the system;
a display for presenting a map of locations; and
at least one hardware based processor coupled to the global positioning receiver and modem, the processor operable to obtain a location from the global position receiver and control the display to present a map of locations adjacent to the location, the processor further operable to control the modem to wirelessly receive information on potential police activity from a source external to the system, and control the display to present the received information on potential policy activity on the map;
wherein the information on potential police activity presented on the display includes one or more of:
the currency of the reported potential police activity;
a frequency band associated with the reported potential police activity; and
a frequency associated with the reported potential police activity.
